(19) United States
(12) Patent Application Publication
(10) Pub. No.: US 2009/0326968 A1
(43) Pub. Date: Dec. 31, 2009

(54) Remotely Retrieving Merged Documents Relating to Cargo for Various Checkpoints

(76) Inventor: Colin Dale Lopez, Mount Arlington, NJ (US)

Correspondence Address: Law Offices of Rita C. Chipperson, P.C., 55 Madison Ave, Suite 400, Morristown, NJ, 07960, US

(21) Appl. No.: 12/164,095

(22) Filed: Jun. 29, 2008

(51) Int. Cl. G06Q 30/00

(52) U.S. Cl. 705/1

(57) ABSTRACT

A shipper ships cargo from an origin to a destination and has documentation in an electronic form for a requester regarding the cargo. The requester is logged into the retrieval system and an interface of the retrieval system is provided to the logged-in requestor to allow same to search for items of documentation relating to such requester and such cargo based on indicia associated with each item. The search results include a number of items of documentation, and an identification of a number of particular ones of the items in the set of search results is received from the requester. The retrieval system creates a merged electronic document containing all of the identified items of documentation and the created merged document is delivered from the retrieval system to one of the requester and a destination selected by the requester.

### COPYRIGHT OR MASK WORK RIGHTS NOTICE

A portion of the disclosure of this patent document may contain material which is subject to copyright or mask work rights protection. The copyright or mask work rights owner has no objection to the facsimile reproduction by anyone of the patent document or the patent disclosure as it appears in the Patent and Trademark Office patent file or records but otherwise reserves all copyright or mask work rights whatsoever.

### BACKGROUND OF THE INVENTION

Embodiments of the present invention generally relate to systems and methods for remotely electronically retrieving documents with information relating to cargo for a checkpoint such as a point of importation. More specifically, the present invention relates to systems and methods for remotely electronically retrieving the documents in the form of a merged electronic file having the documents therein.

As may be appreciated, a shipper shipping cargo is oftentimes required to provide documentation regarding the cargo at various checkpoints or the like. Typically, such documentation is required at a port or the like when importing the cargo into a country or exporting the cargo out of a country, although it is to be appreciated that such documentation may be required at other locations, including when the cargo is moved across borders between countries, when the cargo is moved across borders within a country, when the cargo departs from an origin thereof, when the cargo arrives at a destination thereof, when the cargo is being inspected, and the like.

The cargo itself may be most any cargo in most any form. For example, the cargo may be an individual item such as a transported automobile or industrial machine, or may be a number of items such as a load of crates or boxes or the like, each of which contains one or more items, such as engines, motors, toys, food products, hardware products, processed metals, and/or other industrial or consumer products or the like. Moreover, the cargo may be shipped within a container or the like and comprise the entirety of the container or a portion thereof.

Typically, the documentation regarding the cargo is extensive, and can include a bill of lading, a seaway bill or highway bill or air bill or the like, one or more customer contracts, descriptions of the cargo, descriptions of hazards associated with the cargo, descriptions of special handling required in connection with the cargo, and the like. Also typically, the shipper is the source of such documentation, although such source may also be any other entity as necessary and/or appropriate.

Oftentimes, the shipper of the cargo employs a freight forwarder, custom broker, related agent, or the like in order to effectuate such shipping. As should be understood, the shipper is not necessarily in the business of transporting cargo but instead may be in the business of producing or consuming the cargo. The freight forwarder, custom broker, and/or related agent likely is not in the business of transporting the cargo either but instead provides services to the shipper in the nature of finding an appropriate transporter for the shipper, where the transporter is in fact in the business of transporting the cargo.

Thus, based on considerations such as the origin and the destination of the cargo and when the shipper desires that the cargo is picked up at the origin and dropped off at the destination, the freight forwarder, custom broker, and/or related agent arranges for one or more appropriate transporters to in fact pick up the cargo at the origin at about the desired time and also drop off the cargo at the destination at about the desired time. As may be appreciated, the freight forwarder, custom broker, and/or related agent may arrange for a single transporter to pick up and drop off the cargo, or may arrange for a series of transporters if necessary and/or desired. In the latter case, the freight forwarder, custom broker, and/or related agent may also arrange for storage of the cargo at one or more intermediate locations. As may also be appreciated, the freight forwarder, custom broker, and/or related agent may further arrange for all importation and/or exportation functions in connection with the cargo, including fees, inspection or quarantine or the like, re-packaging if need be, and the like.

Notably, and again, at any of several checkpoints during shipment and/or transportation of the cargo, access to the documentation regarding the cargo may be required. For example, if importing the cargo, a customs agent at the point of importation may require access to at least some of the documentation in order to determine that an importation tax is paid for the cargo at an appropriate rate. Similarly, if storing the cargo at an intermediate point, a clerk may require access to at least some of the documentation in order to determine whether the cargo is combustible or requires special handling.

Typically, the shipper provides the freight forwarder, custom broker, and/or related agent with such documentation and the freight forwarder, custom broker, and/or related agent in turn provides the documentation at the appropriate checkpoints, although other arrangements may also be employed. At any rate, the freight forwarder, custom broker, related agent, or another entity may be required to provide differing documentation at different checkpoints. Accordingly, a need exists for a system and method to allow the shipper to provide such documentation to the freight forwarder, custom broker, related agent, or other entity, particularly in an electronic form so that the documentation may then be forwarded to the checkpoint in such electronic form. Also, a need exists for such a system and method to allow the freight forwarder, custom broker, and/or related agent to select from among the documentation based on the checkpoint and/or other considerations. Further, a need exists for such a system and method to package the selected documentation into a merged form such as a single electronic file so that the selected documentation may be sent in an organized manner.

### BRIEF SUMMARY OF THE INVENTION

Briefly stated, in various embodiments of the present invention a system and method are provided in connection with a shipper shipping cargo from an origin to a destination so as to provide documentation in an electronic form to a requester regarding the cargo. The documentation is destined for a checkpoint comprising one of the origin, the destination, and an intermediate location therebetween. In the method, credentials are received at a documentation retrieval system from the requester communicatively coupled to such retrieval system, and upon receiving the credentials the requester is logged into the retrieval system.

An interface of the retrieval system is provided to the logged-in requester to allow the requester to search for items of documentation relating to such requester and such cargo based on indicia associated with each item. The search results in a set of search results including a number of items of documentation, and an identification of a number of particular ones of the items in the set of search results is received from the requester. The retrieval system creates a merged electronic document containing all of the identified items of documentation upon the logged-in requester actuating a merge option as displayed in the interface, and the created merged document is delivered from the retrieval system to one of the requester and a destination selected by the requestor.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a block diagram of an example of a computing environment within which various embodiments of the present invention may be implemented;

FIG. 2 is a block diagram including an electronic document retrieval system with documentation relating to cargo being shipped from an origin to a destination in accordance with various embodiments of the present invention;

FIG. 3 is a flow diagram showing key actions performed in connection with the retrieval system of FIG. 2 in accordance with various embodiments of the present invention; and

FIGS. 4 and 5 depict an interface of the retrieval system of FIG. 2 as may be viewed by a freight forwarder, custom broker, related agent, or other requester requesting documentation relating to the cargo of FIG. 2, and show indicia by which the documentation may be searched (FIGS. 4 and 5) and items in search results identified to be merged into a document and the merged document (FIG. 5) in accordance with various embodiments of the present invention.

### DETAILED DESCRIPTION OF THE INVENTION

### Terminology

Certain terminology may be used in the following description for convenience only and is not limiting. The words “lower” and “upper” and “top” and “bottom” designate directions in the drawings to which reference is made. The terminology includes the words above specifically mentioned, derivatives thereof and words of similar import.

Where a term is provided in the singular, the inventors also contemplate aspects of the invention described by the plural of that term. As used in this specification and in the appended claims, the singular forms “a”, “an” and “the” include plural references unless the context clearly dictates otherwise, e.g., “a tip” includes a plurality of tips. Thus, for example, a reference to “a method” includes one or more methods, and/or steps of the type described herein and/or which will become apparent to those persons skilled in the art upon reading this disclosure.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods, constructs and materials are now described. All publications mentioned herein are incorporated herein by reference in their entirety. Where there are discrepancies in terms and definitions used in references that are incorporated by reference, the terms used in this application shall have the definitions given herein.

### Example Computing Environment

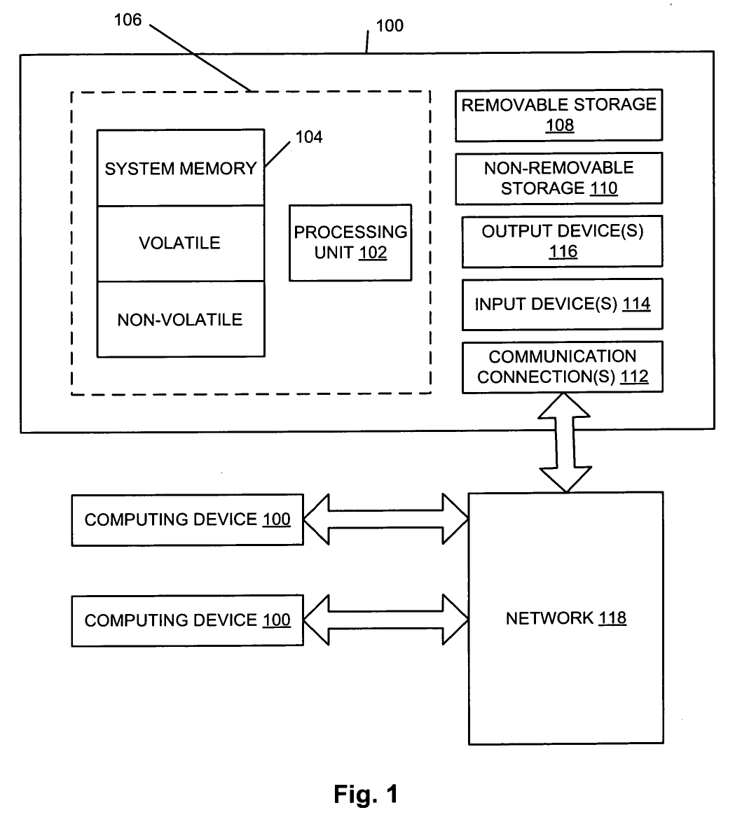

FIG. 1 is set forth herein as an exemplary computing environment in which various embodiments of the present invention may be implemented. The computing system environment is only one example of a suitable computing environment and is not intended to suggest any limitation as to the scope of use or functionality. Numerous other general purpose or special purpose computing system environments or configurations may be used. Examples of well-known computing systems, environments, and/or configurations that may be suitable for use include, but are not limited to, personal computers (PCs), server computers, handheld or laptop devices, multi-processor systems, microprocessor-based systems, network PCs, minicomputers, mainframe computers, embedded systems, distributed computing environments that include any of the above systems or devices, and the like.

Computer-executable instructions such as program modules executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 1, an exemplary system for implementing aspects described herein includes a computing device, such as computing device 100. In its most basic configuration, computing device 100 typically includes at least one processing unit 102 and memory 104. Depending on the exact configuration and type of computing device, memory 104 may be volatile (such as random access memory (RAM)), non-volatile (such as read-only memory (ROM), flash memory, etc.), or some combination of the two. This most basic configuration is illustrated in FIG. 1 by dashed line 106. Computing device 100 may have additional features/functionality. For example, computing device 100 may include additional storage (removable and/or non-removable) including, but not limited to, magnetic or optical disks or tape. Such additional storage is illustrated in FIG. 1 by removable storage 108 and non-removable storage 110.

Computing device 100 typically includes or is provided with a variety of computer-readable media. Computer-readable media can be any available media that can be accessed by computing device 100 and includes both volatile and non-volatile media, removable and non-removable media. By way of example, and not limitation, computer-readable media may comprise computer storage media and communication media.

Computer storage media includes volatile and non-volatile, removable and non-removable media implemented in any method or technology for storage of information such as computer-readable instructions, data structures, program modules or other data. Memory 104, removable storage 108, and non-removable storage 110 are all examples of computer storage media. Computer storage media includes, but is not limited to, RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 100. Any such computer storage media may be part of computing device 100.

Computing device 100 may also contain communications connection(s) 112 that allow the device to communicate with other devices. Each such communications connection 112 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both storage media and communication media.

Computing device 100 may also have input device(s) 114 such as keyboard, mouse, pen, voice input device, touch input device, etc. Output device(s) 116 such as a display, speakers, printer, etc. may also be included. All these devices are generally known to the relevant public and therefore need not be discussed in any detail herein except as provided.

Notably, computing device 100 may be one of a plurality of computing devices 100 inter-connected by a network 118, as is shown in FIG. 1. As may be appreciated, the network 118 may be any appropriate network, each computing device 100 may be connected thereto by way of a connection 112 in any appropriate manner, and each computing device 100 may communicate with one or more of the other computing devices 100 in the network 118 in any appropriate manner. For example, the network 118 may be a wired or wireless network within an organization or home or the like, and may include a direct or indirect coupling to an external network such as the Internet or the like. Likewise, the network 118 may be such an external network.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter.

In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application-program interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language, and combined with hardware implementations.

Although exemplary embodiments may refer to utilizing aspects of the presently disclosed subject matter in the context of one or more stand-alone computer systems, the subject matter is not so limited, but rather may be implemented in connection with any computing environment, such as a network 118 or a distributed computing environment. Still further, aspects of the presently disclosed subject matter may be implemented in or across a plurality of processing chips or devices, and storage may similarly be effected across a plurality of devices in a network 118. Such devices might include personal computers, network servers, and handheld devices, for example.

### Shipping Cargo

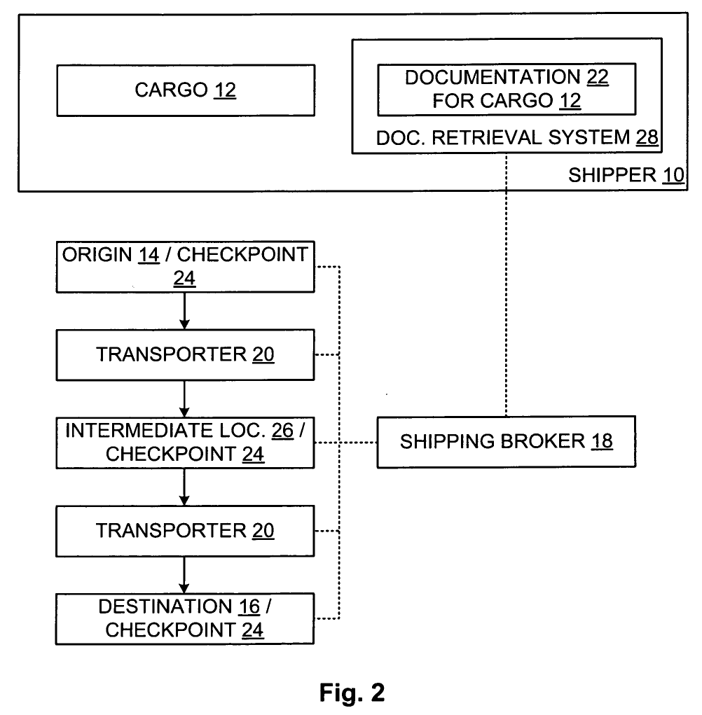

Turning now to FIG. 2, it is seen that a shipper 10 or the like ships cargo 12 from an origin 14 to a destination 16 by way of a shipping broker 18 or the like (e.g., a freight forwarder, a custom broker, a related agent, etc.) that arranges for one or more transporters 20 or the like to in fact carry the cargo 12 from such origin 14 to such destination 16. As should be understood, each of the shipper 10, broker 18, and transporter(s) 20 may be any appropriate shipper, broker, freight forwarder, custom broker, related agent, and transporter, respectively, without departing from the spirit and scope of the present invention. Likewise, the cargo 12, origin 14, and destination 16 may be most any cargo, origin, and destination without departing from the spirit and scope of the present invention.

For example, the cargo 12 may be an individual item such as a transported automobile or industrial machine being transported internationally by way of a cargo ship, or may be a number of items such as a load of crates or boxes or the like, each of which contains one or more items, such as engines, motors, toys, food products, hardware products, processed metals, and/or other industrial or consumer products or the like, where the crates or boxes are being transported across multiple boundaries within a country by way of trucks and trains. Moreover, the cargo 12 may be shipped within a container or the like and comprise the entirety of the container or a portion thereof.

The shipper 10 of the cargo 12 likely does not actually transport such cargo 12 but instead employs the broker 18 to effectuate such transportation. That is, the shipper 10 is not necessarily in the business of transporting the cargo 12 but instead may be a producer or consumer of the cargo 12, among other things. The broker 18 likely is not in the business of transporting the cargo 12 either but instead provides services to the shipper 10 in the nature of finding and engaging each transporter 20 for the shipper 10, where the transporter 20 is in fact in the business of transporting the cargo 12.

Thus, and as was pointed out above, based on considerations such as the origin 14 and the destination 16 of the cargo 12 and when the shipper 10 desires that the cargo 12 is picked up at the origin 14 and dropped off at the destination 16, the broker 18 arranges for the one or more transporters 20 to in fact pick up the cargo 12 at the origin 14 at about the desired time and also drop off the cargo 12 at the destination 16 at about the desired time. The broker 18 may arrange for a single transporter 20 to pick up and drop off the cargo 12, such as for example if the cargo 12 is being transported directly from the origin 14 to the destination 16, or may arrange for a series of transporters 20 if necessary and/or desired, such as for example if the cargo 12 is being transported first to a port by truck, then to another port by ship, then to a destination 16 by rail. In the latter case, and again, the broker 18 may also arrange for storage of the cargo 12 at one or more intermediate locations 26, such as for example warehouses at the aforementioned ports. In any case, and again, the broker 18 may further arrange for all importation and/or exportation functions in connection with the cargo, including fees, inspection or quarantine or the like, re-packaging if need be, and the like.

As was set forth above, it is oftentimes necessary to provide documentation 22 regarding the cargo 12 at various checkpoints 24 or the like including the origin 14, the intermediate locations 26, and the destination 16. As was also set forth above, the documentation 22 regarding the cargo 12 is typically extensive and can include a bill of lading, a seaway bill or highway bill or air bill or the like, one or more customer contracts, descriptions of the cargo, descriptions of hazards associated with the cargo, descriptions of special handling required in connection with the cargo, and the like. Typically, the shipper 10 is the source of such documentation 12, although such source may also be any other entity as necessary and/or appropriate.

For example, such documentation 22 may be required at checkpoints 22 such as at a port or the like when importing the cargo 12 into a country or exporting the cargo 12 out of a country, when the cargo 12 is moved across borders between countries, when the cargo is moved across borders within a country, when the cargo 12 departs from the origin 14 thereof, when the cargo 12 arrives at the destination 16 thereof, when the cargo 12 is being inspected, when the cargo 12 is being stored at any intermediate point, and the like. As may be appreciated, such documentation 22 may be required at a checkpoint 22 for most any reason. For example, if importing the cargo 12, a customs agent at the point of importation may require access to at least some of the documentation 22 in order to determine that an importation tax is paid for the cargo 12 at an appropriate rate. Similarly, if storing the cargo 12 at an intermediate location 26, a clerk may require access to at least some of the documentation 22 in order to determine whether the cargo 12 is combustible or requires special handling.

Typically, the shipper 10 provides the broker 18 with such documentation 22 and the broker 18 in turn provides the documentation 22 at the appropriate checkpoints 24, although other arrangements may also be employed. At any rate, the broker 18 or another entity (e.g., a freight forwarder, customer broker, related agent, etc.) may be required to provide differing documentation 22 at different checkpoints 24.

### Remotely Retrieving Merged Electronic Documents

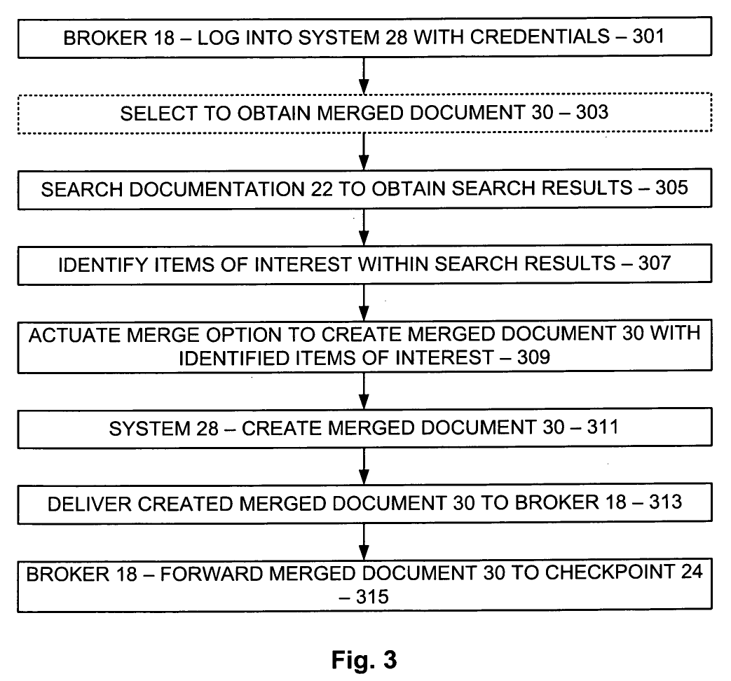

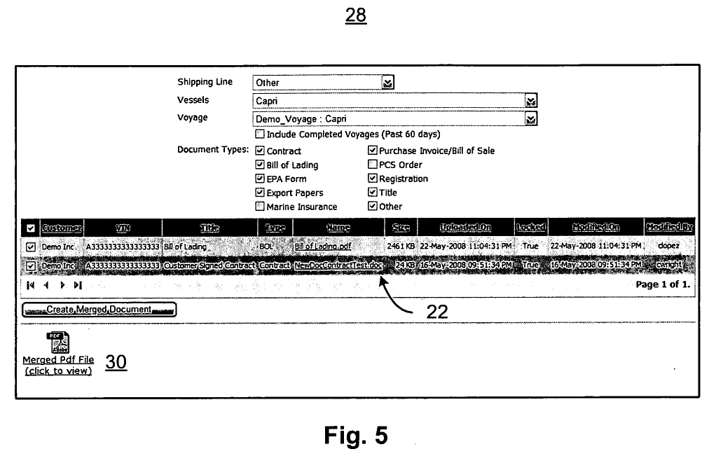

Still referring to FIG. 2, it is seen that in various embodiments of the present invention, the shipper 10 provides the documentation 22 to the broker 18 in an electronic form by allowing the broker 18 to access a documentation retrieval system 28 as provided by or on behalf of the shipper 10 and download the documentation 22 therefrom in the form of a merged electronic document 30 (FIG. 5) that encompasses a single electronic file. Essentially, the retrieval system 28 includes or has access to a database or the like with the documentation 22 stored therein, an interface or the like by which the broker 18 interacts with the system 28 to select from among the documentation 22, a formatter or the like for formatting the selected documentation 22 into the merged document 30, and a deliverer or the like for delivering the merged document 30 to the broker 18. In particular, and turning now to FIG. 3, it is seen that the retrieval system 28 is employed in the following manner.

Preliminarily, it is to be presumed that the broker 18 is provided by way of the retrieval system 28 with access to all documentation 22 for all shipments of the shipper 10 as handled by the broker 18. Also, it is presumed that the broker 18 has already been provided with appropriate credentials for logging in to the retrieval system 28, which as should be appreciated may include a user name, a password, and the like, and that the shipper 10 and the broker 18 each have appropriate hardware and software to allow the broker 18 to gain access to the system 28 by way of a network such as the Internet or the like.

Further, it is to be presumed that each item of documentation 22 in the database of the system 28 is appropriately indexed so as to be retrievable based on a corresponding broker 18 and based on other indicia such as by shipping contract, shipping line, shipping vessel, shipping voyage, type of documentation 22, and the like. As may be appreciated, each shipping contract represents a contract between the shipper 10 and the broker 18 for shipping a particular cargo 12; each shipping line represents a particular transporter 20, such as a steamship operator or a trucking company; each shipping vessel represents a particular shipping vehicle, such as a ship or a truck; and each shipping voyage represents a particular trip of a shipping vehicle, such as the departure scheduled for a particular date from a particular location. As may also be appreciated, the type of documentation 22 may be any appropriate type of a document, such as for example a contract, a bill of lading, a form for an environmental authority, papers for exporting, papers for importing, insurance papers, a purchase order, a purchase invoice or bill of sale, a registration document relating to the cargo 12, a title document relating to the cargo 12, or the like.

All that said, the broker 18 first logs into the system 28 with the credentials thereof (301) and in doing so the system 28 identifies the broker 18 and all of the documentation 22 relating to such broker 18. Thereafter, the broker 18 if necessary selects to obtain documentation 22 as a merged document 30 (303) and the system 28 routes the broker 18 to the corresponding interface. Such interface may be designed in an appropriate manner to allow the broker 18 to search for only that documentation 22 required thereby based on various indicia such as the indicia set forth above. Note that the broker 18 need not select to obtain documentation 22 as a merged document 30 as at 303 if the system 28 provides no other options.

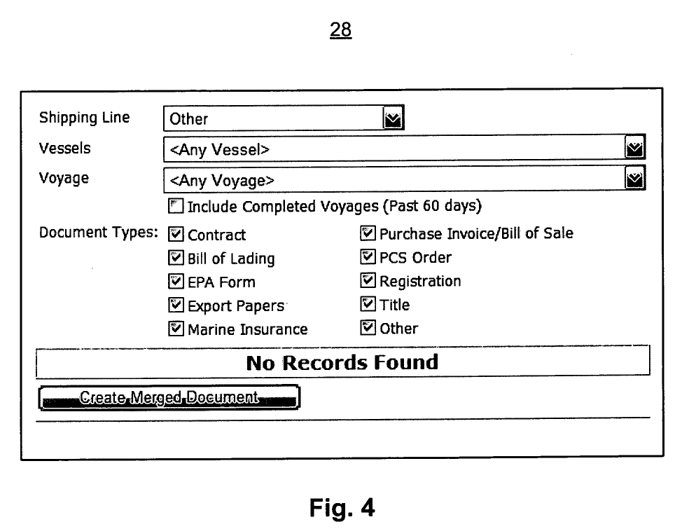

In various embodiments, the broker 18 by way of the interface of the system 28 selects the items of documentation 22 to be formed into the merge document 30 by way of searching the documentation 22 according to the aforementioned indicia to obtain a set of search results (305). For one example, it may be that the broker 18 firsts selects a particular shipping contract for which documentation 22 is sought, then from among the documentation 22 of the selected contract the broker 18 may limit a set of search results based on the shipping line, shipping vessel, shipping voyage, and one or more types of documentation 22 sought, as may be seen in FIG. 4.

For another example (not shown), it may be that the broker 18 first selects a particular shipping vessel and voyage for which documentation 22 is sought, then from among the documentation 22 pertaining to such vessel and voyage, the broker 18 may limit a set of search results based on one or more types of documentation 22 sought. In the latter case, it may be that the documentation 22 sought extends across several shipping contracts. In any case, it may be that the broker 18 may perform the process of limiting the set of search results in an iterative manner until a final set of search results is identified that closely matches the documentation 22 sought. Generally, and as should be appreciated, the search results of 305 may be formed in most any appropriate manner according to the indicia by which the documentation 22 is searchable in the system 28.

In any event, once the system 28 compiles a set of search results according to search parameters set by the broker 18 as at 305, the broker 18 may then identify within the search results the particular items of interest (307), as is seen in FIG. 5, perhaps by selecting each item of interest or by actuating a ‘select all’ option. As may be appreciated in FIG. 5, the cargo 12 is an automobile being exported by way of a scheduled voyage of a ship, and the identified items of documentation 22 of interest with regard to the automobile include a bill of lading and a customer signed contract.

As should be understood, each item of documentation is distinct from every other item, either by being in a separate electronic file, by being separately stored at the system 28, or the like. Thus, once the broker 18 identifies the particular items of documentation 22 of interest, the broker 18 may then create a merged document 30 containing the identified items of documentation 22 of interest by actuating a merge option as displayed in the interface of the system 28 (309). Thereafter, the aforementioned formatter of the system 28 in fact creates the merged document 30 containing the identified items of documentation 22 of interest (311) in an appropriate manner that is known or should be apparent to the relevant public and therefore need not be set forth herein in any detail other than that which is provided.

For example, if all the identified items are in a common format, such as for example a word processing document format, the formatter of the system 28 may merge the identified items into a merged document 30 having the common format. However, if all the identified items are not in a common format, the formatter of the system 28 may first convert those items not in a selected format to the selected format, then may merge all of the identified items into a merged document 30 having the selected format.

Note that inasmuch as the merged document 30 is likely to be delivered by the broker 18 to one or more appropriate checkpoints 24 that may be located most anywhere, as was set forth above, the merged document 30 should be in a format that is widely recognized and readable. Accordingly, it may be that the merged document 30 as produced by the system 28 is in a PDF format such as that produced by the ADOBE ACROBAT document production software application as marketed and/or distributed by ADOBE Systems Incorporated of San Jose, Calif., although other applications may also be employed. Such a merged PDF document 30 is shown in FIG. 5 as being viewable by being clicked on.

At any rate, once the system 28 creates the merged document 30 as at 311, the deliverer of the system 28 delivers the created merged document 30 to the broker 18 (313). Such delivery may be effectuated in any appropriate manner, such as for example by way of a process that employs a file transfer protocol, or by way of sending the document 30 to a predefined electronic mail address of the broker 18. Delivering such a document 30 is known or should be apparent to the relevant public and therefore need not be set forth herein in any detail other than that which is provided. When in possession of the document 30, and again, the broker 18 may then forward such document 30 in an appropriate manner to each of one or more appropriate checkpoints 24 for use thereat in connection with reviewing/inspecting/verifying/taxing/etc. cargo 12 passing such checkpoint 24 (315). Here too, forwarding such document 30 is known or should be apparent to the relevant public and therefore need not be set forth herein in any detail other than that which is provided.

### Conclusion

The programming believed necessary to effectuate the processes performed in connection with the various embodiments of the present invention is relatively straight-forward and should be apparent to the relevant programming public. Accordingly, such programming is not attached hereto. Any particular programming, then, may be employed to effectuate the various embodiments of the present invention without departing from the spirit and scope thereof.

In the present invention, systems and methods allow a shipper 10 of cargo 12 to provide documentation 22 to a shipping broker 18 or other entity (e.g., a freight forwarder, custom broker, related agent, etc.), particularly in an electronic form so that the documentation 22 may then be forwarded to a checkpoint 24 in such electronic form. The broker 18 can select from among the documentation 22 based on the checkpoint 24 and/or other considerations. The selected documentation 22 is packaged into a merged document 30 such as a single electronic file so that the selected documentation 22 may be sent in an organized manner.

It should be appreciated that changes could be made to the embodiments described above without departing from the inventive concepts thereof. For example, although the system 28 is set forth primarily in terms of use thereof by a shipping broker 18, other entities may also use the system 28, such as for example a person at a checkpoint 24, a freight forwarder, a custom broker, a related agent, etc. Likewise, although the present invention is set forth primarily in terms of a system 28 used in connection with shipping cargo 12, other types of shipments may also be employed with the system 28. It is understood, therefore, that this invention is not limited to the particular embodiments disclosed, but it is intended to cover modifications within the spirit and scope of the present invention as defined by the appended claims.

I claim:

1. A method performed in connection with a shipper shipping cargo from an origin to a destination, the method for providing documentation in an electronic form to a requestor regarding the cargo, the documentation destined for a checkpoint comprising one of the origin, the destination, and an intermediate location therebetween, the method comprising:
receiving at a documentation retrieval system credentials from the requestor communicatively coupled to such retrieval system, and upon receiving the credentials logging the requestor into the retrieval system;
providing an interface of the retrieval system to the logged-in requestor to allow the requestor to search for items of documentation relating to such requestor and such cargo based on indicia associated with each item, the search resulting in a set of search results including a number of items of documentation;
receiving at the retrieval system from the logged-in requestor an identification of a number of particular ones of the items in the set of search results;
creating at the retrieval system a merged electronic document containing all of the identified items of documentation upon the logged-in requestor actuating a merge option as displayed in the interface; and
delivering the created merged document from the retrieval system to one of the requestor and a destination selected by the requestor.

2. The method of claim 1 wherein the cargo is an automobile.

3. The method of claim 1 wherein the checkpoint is a customs office at a point of importation.

4. The method of claim 1 wherein the checkpoint is one of a warehouse where the cargo is being stored while in shipment from the origin to the destination, a border between countries that the cargo moves across, a border within a country that the cargo moves across, and a location where the cargo is being inspected.

5. The method of claim 1 wherein the documentation regarding the cargo includes at least one of a bill of lading, a seaway bill, a highway bill an air bill, a customer contract, a description of the cargo, a description of a hazard associated with the cargo, a description of special handling required in connection with the cargo, a form for an environmental authority, papers for exporting, papers for importing, insurance papers, a purchase order, a purchase invoice/bill of sale, a registration document relating to the cargo, and a title document relating to the cargo.

6. The method of claim 1 wherein the shipper generates the documentation.

7. The method of claim 1 wherein the shipper ships the cargo from an origin to a destination by way of an entity selected from the group consisting of a freight forwarder, a custom broker, a related agent, and combinations thereof, the method for providing the entity with the documentation in the electronic form regarding the cargo, the documentation to be forwarded by the entity to the checkpoint.

8. The method of claim 1 wherein the indicia associated with each item of documentation includes a shipping contract representing a contract of the shipper for shipping the cargo, each shipping line transporting the cargo, each shipping vessel shipping the cargo, each shipping voyage upon which the cargo is shipped, and a type of documentation associated with the item.

9. The method of claim 1 wherein the retrieval system merges the identified items into a merged document having a common format, the common format being a PDF format.

10. The method of claim 1 wherein the created merged document is delivered by way of one of a file transfer protocol and an email transfer protocol.

11. A documentation retrieval system employed in connection with a shipper shipping cargo from an origin to a destination, the retrieval system for providing documentation in an electronic form to a requester regarding the cargo, the documentation destined for a checkpoint comprising one of the origin, the destination, and an intermediate location therebetween, the retrieval system comprising:
an access sub-system that receives credentials from the requester communicatively coupled to such retrieval system, and that upon receiving the credentials logs the requester into the retrieval system;
an interface that allows the logged-in requester to search for items of documentation relating to such requester and such cargo based on indicia associated with each item, the search resulting in a set of search results including a number of items of documentation, and that receives from the logged-in requestor an identification of a number of particular ones of the items in the set of search results;
a formatter that creates a merged electronic document containing all of the identified items of documentation upon the logged-in requestor actuating a merge option as displayed in the interface; and
a deliverer that delivers the created merged document from the retrieval system to one of the requester and a destination selected by the requestor.

12. The system of claim 11 wherein the cargo is an automobile.

13. The system of claim 11 wherein the checkpoint is a customs office at a point of importation.

14. The system of claim 11 wherein the checkpoint is one of a warehouse where the cargo is being stored while in shipment from the origin to the destination, a border between countries that the cargo moves across, a border within a country that the cargo moves across, and a location where the cargo is being inspected.

15. The system of claim 11 wherein the documentation regarding the cargo includes at least one of a bill of lading, a seaway bill, a highway bill an air bill, a customer contract, a description of the cargo, a description of a hazard associated with the cargo, a description of special handling required in connection with the cargo, a form for an environmental authority, papers for exporting, papers for importing, insurance papers, a purchase order, a purchase invoice/bill of sale, a registration document relating to the cargo, and a title document relating to the cargo.

16. The system of claim 11 wherein the shipper generates the documentation.

17. The system of claim 11 wherein the shipper ships the cargo from an origin to a destination by way of an entity selected from the group consisting of a freight forwarder, a custom broker, a related agent, and combinations thereof, the system for providing the entity with the documentation in the electronic form regarding the cargo, the documentation to be forwarded by the entity to the checkpoint.

18. The system of claim 11 wherein the indicia associated with each item of documentation includes a shipping contract representing a contract of the shipper for shipping the cargo, each shipping line transporting the cargo, each shipping vessel shipping the cargo, each shipping voyage upon which the cargo is shipped, and a type of documentation associated with the item.

19. The system of claim 11 wherein the retrieval system merges the identified items into a merged document having a common format, the common format being a PDF format.

20. The system of claim 11 wherein the created merged document is delivered by way of one of a file transfer protocol and an email transfer protocol.
